(19) United States
(12) Patent Application Publication
(10) Pub. No.: US 2005/0165854 A1
(43) Pub. Date: Jul. 28, 2005

(54) System for managing job performance and status reporting on a computing grid

(76) Inventors: Robert J. Burnett, Dakota Dunes, SD (US); James L. Kroening, Dakota Dunes, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/763,598

(22) Filed: Jan. 23, 2004

(51) Int. Cl. G06F 12/00

(52) U.S. Cl. 707/200

(57) ABSTRACT

A system is disclosed for managing the performance and monitoring the status of a grid job on a grid computer of a computing grid. One aspect of the system contemplates creating a file of at least one job performance factor governing performance of grid jobs on a particular grid computer and performing the grid job on the grid computer in conformance with each job performance factor for the grid computer. Another aspect of the system contemplates forming a grid job for being performed by at least one grid computer, creating a job performance file based on the grid job, and sending the job performance file with the grid job to one of the grid computers.

### BACKGROUND OF THE INVENTION

1. Field of the Invention

The present invention relates to grid computing systems and more particularly pertains to a system for managing job performance and status reporting on a computing grid.

2. Description of the Prior Art

Grid computing, which is sometimes referred to as distributed processing computing, has been proposed and explored as a means for bringing together a large number of computers of wide ranging locations and often disparate types for the purpose of utilizing idle computer processor time and/or unused storage by those needing processing or storage beyond their capabilities. While the development of public networks such as the Internet has facilitated communication between a wide range of computers all over the world, grid computing aims to facilitate not only communication between computers but also to coordination of processing by the computers in a useful manner. Typically, jobs are submitted to a managing entity of the grid system, and the job is executed by one or more of the grid computers making up the computing grid.

However, while the concept of grid computing holds great promise, the execution of the concept has not been without its challenges. One challenge associated with grid computing is adapting to different performance and operational conditions on different computers. Another challenge of grid computing is monitoring the status of ongoing jobs without encumbering the managing entity of the computing grid with constant status requests for each job that is in process.

In traditional grid, multi-processing, or distributed processing systems, a management entity oversees the distribution or assignment of tasks to the various resources on the system, such as nodes or computers having processing or storage capabilities. Typically, if a task assigned to one node is not completed in a reasonable amount of time, the task is reassigned to a different node. Often a reasonable amount of time is generally very short. While the reassignment of tasks that are not performed within a reasonable amount of time certainly causes some performance deterioration in the throughput of the distributed processing system, heretofore the effect has not been too dramatic because the tasks handled have been relatively small.

However, as distributed processing systems are being increasingly moved into the marketplace, the tasks that are being assigned to the nodes are more time consuming and may take hours or even days to perform, so a task that has apparently failed at one node and has been reassigned to another node can greatly harm the overall performance of the system. The management entities for these systems have attempted to resolve the resulting unpredictability in performance by assigning the tasks redundantly, i.e., by assigning the same task to more than one node at the same time, rather than waiting for a particular period of time to pass before reassigning the task. The redundancy often resolves the unpredictability in completing tasks but only does so by dramatically reducing the overall throughput of the system, as tasks that could be performed by one node are automatically assigned to two or more nodes. This reduction in performance is even more pronounced in personal computer grids operating over the Internet, where it is common to use triple redundancy, or assign the same task to three different nodes at the same time.

Another obstacle to achieving peak performance from distributed processing systems is that the processing or computing tasks are designed to make use of unused resources on the node whenever the system of the node is “on” or powered up. Some tasks have been designed so that they only work during certain hours or time periods, such as periods after business hours or overnight when it is unlikely that the system of the node will be used locally. However, the known processes for handling usage times for the nodes have been fairly unsophisticated and manually implemented. Also, while some attention has been paid to the typical usage patterns of the systems of the nodes, other variables governing usage of the nodes have largely been ignored.

Still another obstacle to peak performance is that the known distributed processing systems often require the primary user of the system of the node to manually gain access to a linking network (such as by dialing up or logging on to an Internet Service Provider) and then to a task managing or distributing entity. The lengthiness and cumbersomeness of this process can cause long delays in the completed tasks being returned to the managing entity, especially if the user of the system of the node fails to log on frequently. Completed tasks may thus languish on the system of the node until the user chooses to access the linking network.

In view of the foregoing, it is believed that there is a need for a system that provides a more reliable and complete way of managing the performance of jobs on different computers of a distributed computing system while also providing improved job status monitoring.

### SUMMARY OF THE INVENTION

In view of the difficulties faced by grid computing systems that are set forth above, the present invention discloses a system for managing job performance and status reporting on a computing grid.

In one aspect of the invention, a system is disclosed for managing performance of a grid job on a grid computer of a computing grid. The system includes creating a file of at least one job performance factor governing performance of grid jobs on a particular grid computer and performing the grid job on the grid computer in conformance with each job performance factor for the grid computer.

In a further aspect of the invention, a system is disclosed for monitoring the status of a grid job on a computing grid. The system includes forming a grid job for being performed by at least one grid computer, creating a job performance file based on the grid job, and sending the job performance file with the grid job to one of the grid computers.

Advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred implementations of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic diagram of a computing grid system suitable for the practice of the present invention.

FIG. 2 is a schematic representation of information flow between a grid manager and a grid computer in one aspect of the operation of the present invention.

FIG. 3 is a schematic representation of information flow between the grid manager and the grid computer in another aspect of the operation of the present invention.

FIG. 4 is a schematic flow diagram of the aspect of the operation of the present invention depicted in FIG. 2.

FIG. 5 is a schematic flow diagram of the aspect of the operation of the present invention depicted in FIG. 3.

FIG. 6 is a schematic flow diagram of another aspect of the operation of the present invention.

### DESCRIPTION OF PREFERRED EMBODIMENTS

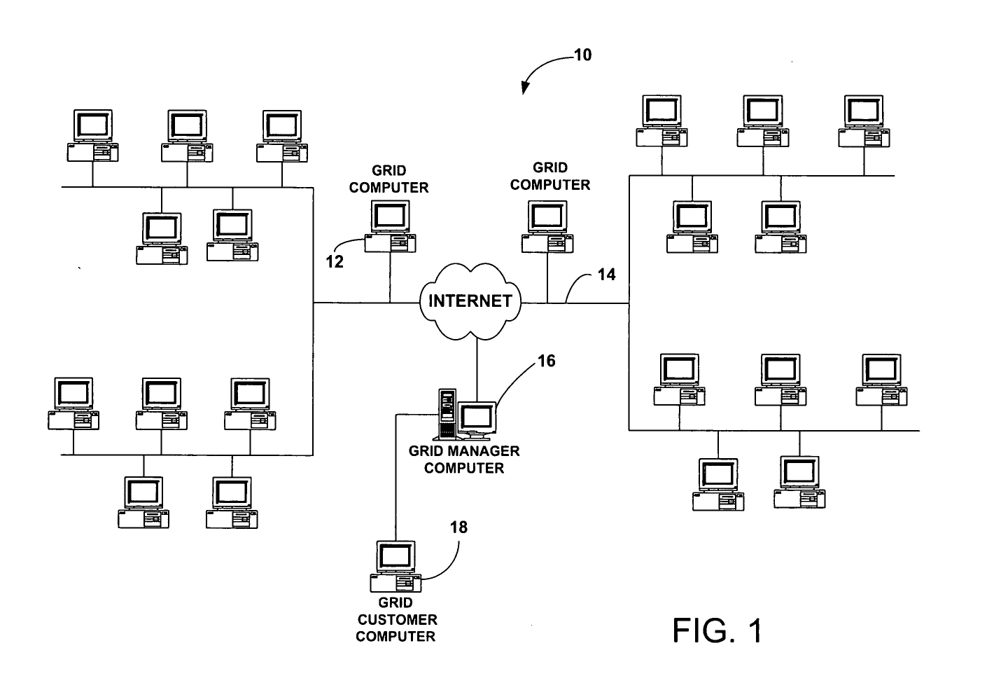

With reference now to the drawings, and in particular to FIGS. 1 through 6 thereof, a system for managing job performance and status reporting on a computing grid that embodies the principles and concepts of the present invention will be described.

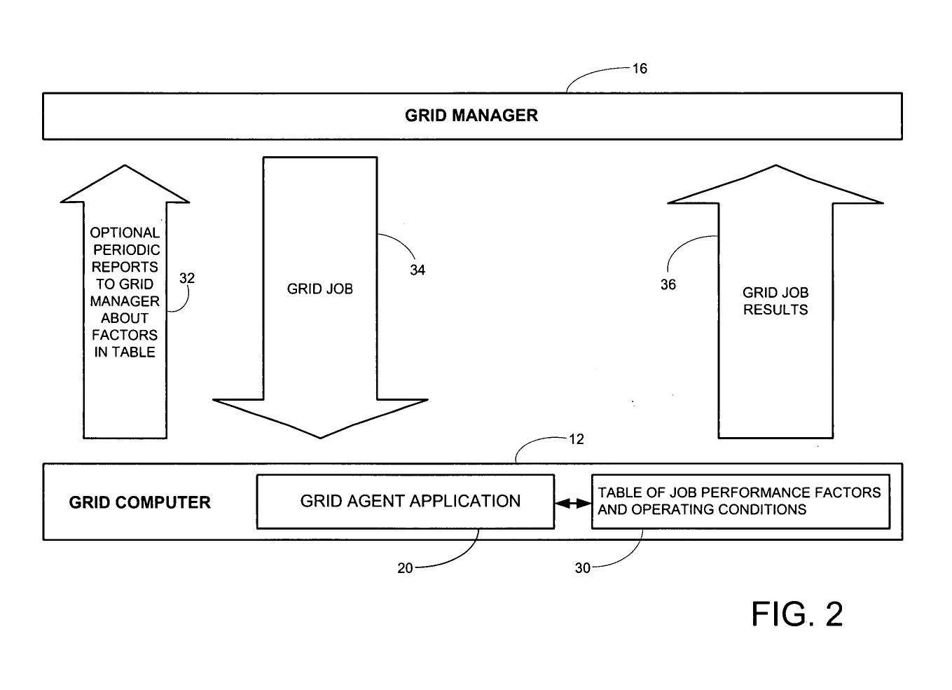

In an illustrative computing grid system 10 suitable for the practice of the invention (see FIG. 1), a plurality of grid computers 12 linked or interconnected together for communication therebetween (such as by a linking network 14), with a grid manager computer 16 designated to administer the grid system. Each of the grid computers 12 may be provided with a grid agent application 20 (see FIG. 2) resident on the grid computer for communicating and interfacing with the grid manager 16 and administering local grid operations on the grid computer. In operation, a customer's computer 18 (see FIG. 1) submits a job or storage task to the grid system 10, typically via the grid manager computer 16 which initially receives jobs for processing or data for storing by the grid system. The client computer 18 may be one of the grid computers 12 on the grid system, or may be otherwise unrelated to the grid system 10. The grid manager 16 may be a computing grid server or host adapted for accepting processing jobs or storage tasks from the customer computer 18, assigning and communicating the job to one of the grid computers 12, receiving results from the grid computer, and communicating the final result back to the customer computer.

In one embodiment of the invention, at least one of the grid computers 12 is located physically or geographically remote from at least one of the other grid computers, and in another embodiment, many or most of the grid computers are located physically or geographically remote from each other. The grid computers 12 and the grid manager computer 16 are linked in a manner suitable for permitting communication therebetween. The communication link between the computers may be a dedicated network, but also may be a public linking network 14 such as the Internet.

In one aspect of the invention, a table 30 or file or other data structure may be established that includes various job performance factors and operating conditions for performing grid jobs on each grid computer (see FIG. 2). The job performance factors may affect the promptness with which a grid job may be performed by the grid computer, and generally will vary from computer to computer, especially with the non-homogeneous nature of computers (and their primary users) that is often characteristic of a computing grid.

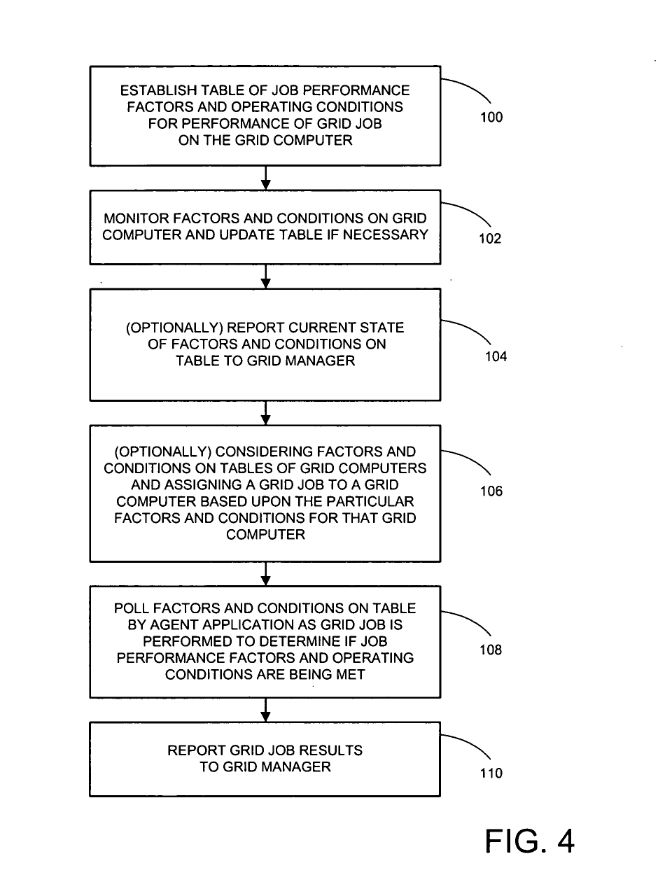

The local grid agent application 20 that is resident on the grid computer may establish the table 30 (block 100 in FIG. 4) on the grid computer 12 and then monitor and maintain the various factors and operating conditions recorded in the table (block 102). Optionally, the job performance factors in the table 30 may be periodically reported in a report 32 submitted to (or otherwise accessed by) the grid manager (block 104). The grid manager may consider the current state of the factors and conditions for the grid computer in the table 30 when assigning grid jobs to that particular grid computer (block 106). Once a grid job 34 is assigned to be performed by the grid computer 12, the grid agent application 20 may poll or examine the table 30 during performance of the grid job to ensure that the factors and conditions set forth in the table are being observed in performing the job (block 108). Upon completion of the grid job 34, the grid job results 36 are reported back to the grid manager 16 (block 110).

The job performance factors and operating conditions recorded on the table 30 may be periodically updated to reflect changes in the individual grid computers 12, and the grid agent application 20 may monitor these factors either periodically or on a continuous basis. Optionally, the primary user or administrator of the grid computer 12 may change some or all of the performance factors or operating conditions in the table as situations change. The grid agent application 20 may facilitate this change by providing an interface for making the changes to the table 30. The agent application 20 may also report to the grid manager 16 any changes made to the table.

The table 12 for a particular grid computer 12 is preferably maintained on the same grid computer for ease of updating the factors and conditions and for monitoring or polling the current state of the factors and conditions on the table by the agent application 20 managing the performance of a grid job on the grid computer. Optionally, the table 30 could be located, for example, on a local server, on the grid manager 16, or even elsewhere on the Internet.

One of the job performance factors that is recorded in the table 30 may be the amount, if any, of processor time utilization that must be reserved for processing local tasks or performing local operations on the grid computer 12, which can affect how much time on the grid computer can be devoted to performing the grid job 34 and thus can affect how quickly the grid job can be performed. For example, the performance of grid jobs may be limited to only 50 percent or less of the total processor operating time. Another of the job performance factors that may be included in the table 30 is any operating time window to which the performance of grid jobs may be limited on the grid computer, which can also affect how quickly a grid job can be performed. For example, grid jobs may be limited to being performed during non-business hours, such as the period between 6 P.M. and 6 A.M. Yet another job performance factor that may be included is the minimum period of idle processor time that must pass on the grid computer before performance of a grid job may be invoked or continued. For example, at least 10 minutes of idle processor time may be required to pass before the processor may be used to perform the grid job.

A further job performance factor that may be included in the table 30 may be an indication or representation of the relative availability of a network connection for the grid computer 12. This factor may assign a relatively higher value to a more continuous network connection than to a more intermittent or interrupted network connection. A still further job performance factor may be an indication or representation of relative performance of the network connection for the grid computer. This factor may assign a relatively higher value to a relatively faster network connection than a relatively slower network connection.

One of the operating conditions that may be recorded in the table 30 is an indication of at least one time period of optimal electricity rates for operating the particular grid computer 12. Thus, in areas where the electricity rate fluctuates during the day or during the week, the time period or periods when the electricity rate is relatively lower can be indicated and the performance of grid jobs on the grid computer can be limited to those time periods. Another operating condition that may be recorded in the table 30 is an indication of the typical ambient temperature in an environment in which the grid computer is located. The environment of the grid computer may be defined as a room in which the grid computer is located.

A further one of the operating conditions recorded in the table 30 may be an indication of the occurrence of any security breaches for the particular grid computer 12. If a security breach occurs, this occurrence can be recorded in the table 30 and the grid agent application may note the security breach and determine if performance of the grid job should proceed. Further, this condition may affect what security level the grid computer is considered to have by the grid manager, and what types of grid jobs may be securely assigned to the grid computer by the grid manager 16. A still further operating condition that may be recorded in the table 30 is an indication of any virus alerts that may have occurred on the grid computer 12. The indication of the presence of a virus may also trigger a determination by the grid agent application as to whether further performance of the grid job should occur, and may cause the grid manager to delay or halt further grid job assignments to the grid computer until the virus alert indication has been removed from the table 30.

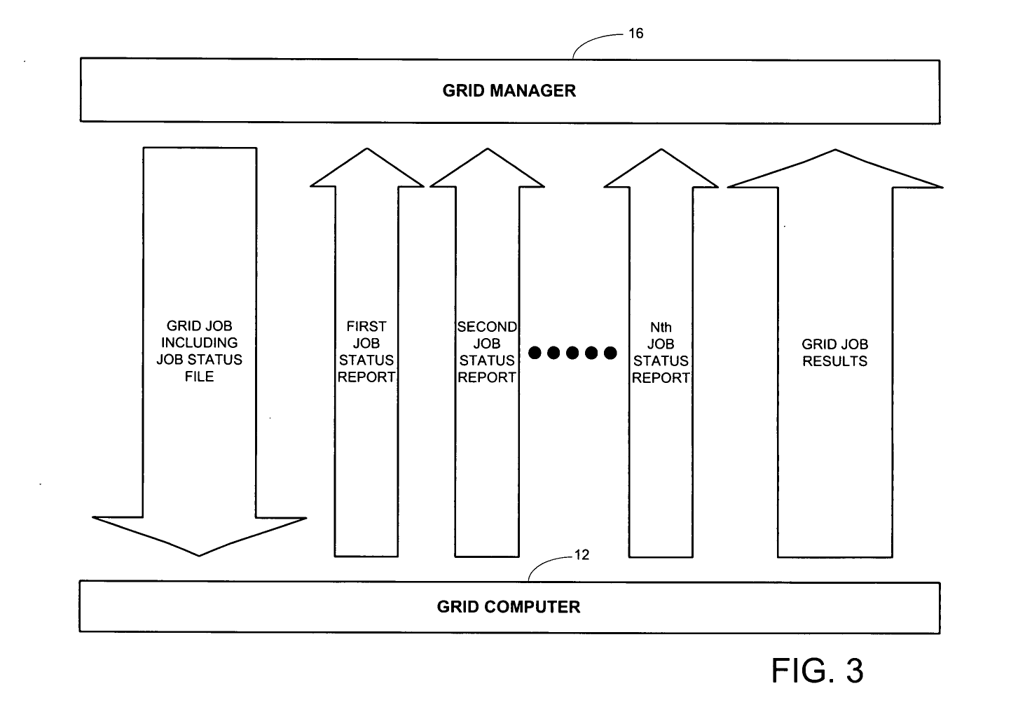

Another aspect of the invention contemplates the creation of a job performance file directed to a particular grid job. The job performance file may be created as a part of the formation of the grid job, and may be transmitted with the grid job to one of the grid computers (see FIG. 3). The job performance file may be created by the grid manager 16, or any entity involved in the creation or delegation or assignment of grid jobs to the grid computers.

In one implementation of the invention, the job performance file includes a plurality of elements or fields. The information in the fields of the job performance file may depend upon on the particular grid job.

The job performance file may include at least one milestone to be reached in performing the grid job. The milestone or milestones may be defined in the job performance file, and may comprise one or more intermediate steps or stages in the performance of the grid job that should occur before the performance of the grid job is complete. With this feature, the grid manager 16 is kept informed of the actual progress of the performance of the grid job. Thus the grid manager does not have to wait until the grid job is fully completed to be informed of the performance of the grid job, but may be provided with ongoing reports of substantive progress at significant stages of the performance of the grid job. Optionally, the grid job may report partial results of the grid job processing up to the point of the milestone if the nature of the grid job permits meaningful results to be given at these intermediate points in the performance of the grid job.

The job performance file may also include at least one expected time period for each milestone in the job performance file. The expected time period for each milestone indicates a predicted time period in which the milestone is expected to be achieved if performance of the grid job proceeds as expected. This expected time period may be based upon factors particular to the grid computer, such as speed of the computer's processor and the amount of time that the grid computer is expected to spend on performing the job (as opposed to handling local processing tasks). With this feature, the grid manager 16 (and the grid agent application 20) has a standard against which to judge the timing of the achievement of the milestones to determine if the timing of the milestones is consistent with the performance expectations for the particular grid computer for the particular grid job. The grid manager may evaluate the actual performance of the grid job by the grid computer against the expectations, and determine if the grid job needs to be reassigned to another grid computer.

The job performance file may also include at least one deadline for reporting status of the performance of the grid job to the grid manager. The deadline or deadlines in the job performance file are known to the grid manager 16, and the grid manager expects to receive notice from the grid job (or the agent application on the grid computer) by, or optionally shortly after, the passing of the deadline regardless of any milestones achieved). With this feature, the grid manager may keep track of the progress of the performance of the job while the job is in progress, even under circumstances where the job has not achieved one or more of the milestones for reporting back to the grid manager.

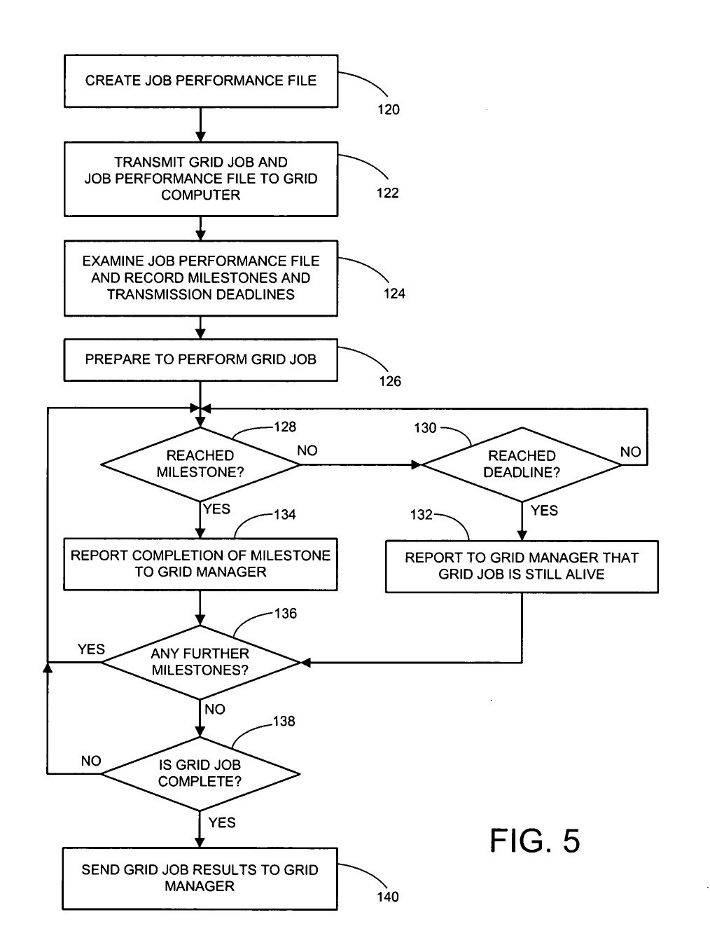

Illustratively, as depicted in FIG. 5, the grid manager 16 may create a job performance file (block 120) and transmit the job performance file to the grid computer with the grid job (block 122). The grid computer, preferably through the grid agent application 20, examines the job performance file when the grid job is received by the grid computer (block 124). The agent application prepares to perform the grid job on the grid computer when conditions on the grid computer permit (block 126). The agent application checks on the progress of the performance of the grid job, if any, and determines if a milestone from the job performance file is reached (block 128). The agent application also determines when the deadlines for transmitting back to the grid manager are reached (block 130). When a deadline has been reached, whether or not a milestone has been reached, the grid computer reports to the grid manager that the grid job is still alive and operating (block 132), even if the grid manager has not received notification of any milestones being reached. If there are further milestones to be reached in the performance of the grid job (block 136), the agent application waits for the further milestones to be achieved or deadlines to be met. Once a milestone has been reached (block 128), the grid computer reports back to the grid manager that the milestone has been attained (block 134). The agent application checks the job performance file to see if there are further milestones to be obtained (block 136), and if so, waits for the next milestone or deadline to be reached. If there are not further milestones to be reached, the agent checks to see if the grid job has been completed (block 138), and if not, the agent waits for the next milestone of deadline. If the grid job has been completed, the grid computer sends the grid job results to the grid manager (block 140) and waits for the next grid job to be received.

In this implementation, the lack of achieving milestones in performing the grid job does not prevent the agent application from reporting back to the grid manager at the deadlines, thereby informing the grid manager that while one or more milestones may not be have been yet achieved, the grid job is still alive at the grid computer. This is especially effective where unexpected heavy local use of the resources of the grid computer has held up the performance of the grid job and thus the milestones are not being achieved within the expected time periods. Under these circumstances, the grid manager is thus also informed that the grid job has not been lost, the grid computer has not crashed, but that conditions have moved performance of the job outside of the expected time frame or frames. Thus the grid manager may decide whether to continue to wait for the completion of the grid job by the presently assigned grid computer, or to reassign the grid job to another computer, but does not have to assume that because the grid job results have not arrived during the expected time period, the grid job will not be completed by the assigned grid computer.

The status reports from the grid agent application or the grid computer to the grid manager may also include an indication of the “on time”, or the time that the grid computer system is actually active or powered up. The reporting to the grid manager may also include a report of the relative availability of the resources of the grid computer to the performance of the grid job, or the time that the grid computer actually spends performing the grid job relative to the time that the grid computer spends performing local tasks. This information can be used in predicting the future performance of the current grid job and can also affect future grid jobs to be assigned to the grid computer.

The grid manager 16 may wait for receipt of the status report from the grid job by the end of the time period in which the completion of the milestone is expected, and if the grid job does not report status back to the grid manager by one or more of the deadlines, the grid manager may reassign the grid job to at least one other of the grid computers of the computing grid.

Optionally, in one implementation of the invention, a data set for the grid job may be divided into at least two portions. A first portion of a data set may be sent with the grid job to one of the grid computers for being processed on the grid computer. A second portion of the data may be sent to the grid computer when the status reports to the grid manager show satisfactory progress in the performance of the grid job on the first portion of the data, even if the grid computer has not completed the processing of the first portion of the data.

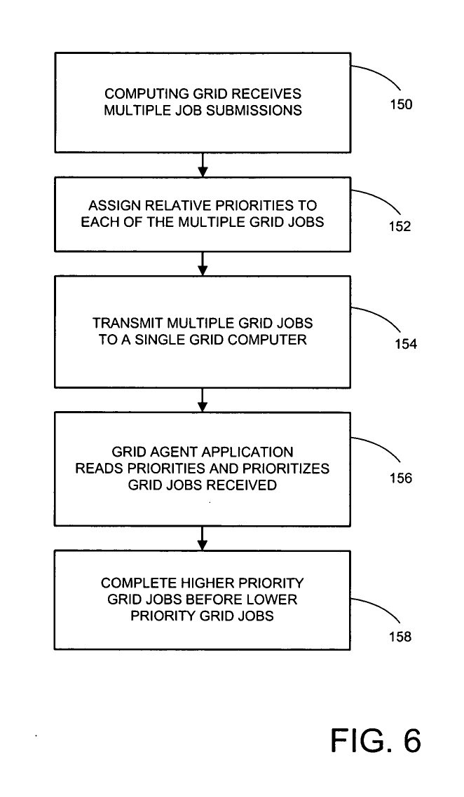

In another aspect of the invention, the performance of multiple grid jobs by a single grid computer on the computing grid is facilitated (see FIG. 6). When multiple job submissions are received by the computing grid (block 150), a relative priority or level of importance is assigned to at least two grid jobs that are to be submitted to the same grid computer (block 152). The two or more grid jobs may be submitted to one of the grid computers on the computing grid (block 154), and the relative priorities of the two grid jobs are disclosed to the grid agent application 20 resident on the grid computer. The agent application may schedule or prioritize processing time on the grid computer according to the relative priority of the grid jobs received by the grid computer (block 156). The grid job or jobs with higher priority are then completed by the grid computer before grid jobs with relatively lower priority (block 158). In one implementation, a first grid job has a relatively higher priority than a second grid job and is as a result performed to completion before the performance of the second grid job is attempted. In another implementation, at least a portion of the first grid job is performed while at least a portion of the second grid job is being performed, with the performance of the first grid job taking some priority in the use of computing resources on the grid computer with respect to the second grid job. With this feature, multiple grid jobs may be assigned to the same grid computer at the same time or about the same time, while providing the grid agent application and the grid computer with guidance as to which job to give priority to when handling performance of two or more grid jobs.

In another aspect of the invention, the grid computer 12 is enabled (such as by operation of the grid agent application 20) to automatically activate a connection with the linking network 14 to link the grid computer to the grid manager for communicating grid job results to the grid manager or for communicating the job status reports described above. For example, the grid agent application 20 may cause the modem of the grid computer 12 to dial up the Internet Service Provider (ISP) providing the Internet connection for the grid computer to permit the transfer of grid job results or status reports to the grid manager. Optionally, in situations where the grid computer 12 is always connected to the Internet (for example, by cable modem), the agent application may activate or wake up the Internet browser or other network interface software application to permit an active communication to be initiated with the grid manager 16. With this feature, the status reports described above (e.g., sent at various milestones or deadlines) can be transmitted to the grid manager in a more timely fashion even if the user of the grid computer has not maintained an active connection with the linking network. As a result, the grid computer is not prevented from reporting at the various milestones and deadlines simply because the network connection for the grid computer is not actively maintained.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

1. A method of managing performance of a grid job on a grid computer of a computing grid, comprising:
creating a file of at least one job performance factor governing performance of grid jobs on a particular grid computer; and
performing the grid job on the grid computer in conformance with each job performance factor for the grid computer.

2. The method of claim 1 wherein creating the file of at least one job performance factor includes storing the file on the grid computer to which the job performance factors apply.

3. The method of claim 1 additionally including reporting the file of the at least one job performance factor to a grid manager that assigns grid jobs to grid computers of the computing grid.

4. The method of claim 1 additionally including accessing the file of at least one job performance factor of one of the grid computers before assigning a grid job to the grid computer.

5. The method of claim 4 additionally including assigning a grid job to a grid computer based upon the at least one job performance factor in the file.

6. The method of claim 1 wherein the at least one job performance factor includes an amount of processor time utilization to reserve for processing local jobs on the grid computer.

7. The method of claim 1 wherein the at least one job performance factor includes an operating time window for performing grid jobs on the grid computer.

8. The method of claim 1 wherein the at least one job performance factor for one of the grid computers is different than at least one job performance factor for another one of the grid computers.

9. The method of claim 1 wherein creating the file additionally comprises including at least one local operating condition for the grid computer in the file, and wherein the at least one local operating condition recorded in the file comprises an indication of at least one time period of optimal electricity rate for operating the grid computer.

10. The method of claim 1 wherein creating the file additionally comprises including at least one local operating condition for the grid computer in the file, and wherein the at least one local operating condition recorded in the file comprises an indication of any virus alerts for the grid computer.

11. A method of monitoring status of a grid job on a computing grid including at least two grid computers, comprising
forming a grid job for being performed by at least one grid computer;
creating a job performance file based on the grid job; and
sending the job performance file with the grid job to one of the grid computers.

12. The method of claim 11 wherein the job performance file includes at least one milestone to be reached in performing the grid job before completion, and additionally including reporting to a grid manager by the grid computer when each milestone is reached.

13. The method of claim 12 wherein the job performance file includes at least one expected time period for each milestone in which the milestone is expected to be achieved.

14. The method of claim 12 additionally including dividing a data set for the grid job into at least two portions, sending a first portion of a data set with the grid job to one of the grid computers for being processed on the grid computer, and sending a second portion of the data to the grid computer when the grid computer reports the achievement of one of the milestones.

15. The method of claim 11 wherein the job performance file includes at least one deadline for reporting status of the performance of the grid job to a grid manager, and additionally including reporting to the grid manager by the grid computer when each deadline is reached.

16. The method of claim 15 additionally including assigning the grid job to at least one other grid computer if the grid computer does not report to the grid manager by the at least one deadline.

17. The method of claim 11 wherein the job performance file includes at least one milestone to be reached in performing the grid job before completion and at least one deadline for reporting status of the performance of the grid job to the grid manager, and additionally including reporting to a grid manager by the grid computer when each deadline occurs regardless of whether the at least one milestone has been reached.

18. The method of claim 11 wherein the job performance file includes a relative priority for performing the grid job, and additionally including performing by the grid computer a grid job having a relatively higher priority before a grid job having a relatively lower priority.

19. The method of claim 13 wherein reporting to the grid manager additionally includes initiating a network connection between the grid computer and a grid manager computer when a network connection is not active and transmitting the report over the network connection.

20. The method of claim 12 wherein reporting to the grid manager additionally includes reporting a level of availability of resources of the grid computer to the grid manager.
